(19) United States
(12) Patent Application Publication
(10) Pub. No.: US 2017/0069025 A1
(43) Pub. Date: Mar. 9, 2017

(54) ALERTING METHOD BY USING TREND LINES OF SECURITY INFORMATION

(71) Applicant: Fonestock Technology Inc., Taipei (TW)

(72) Inventors: Albert Chu Tsung Chen, Taipei City (TW); Yi-Hsuan Kuo, Taipei (TW)

(73) Assignee: Fonestock Technology Inc., Taipei (TW)

(21) Appl. No.: 15/346,604

(22) Filed: Nov. 8, 2016

Related U.S. Application Data
(63) Continuation-in-part of application No. 14/822,336, filed on Aug. 10, 2015.

(30) Foreign Application Priority Data
Nov. 17, 2015 (TW) 104137914

(51) Int. Cl. G06Q 40/04

(52) U.S. Cl. CPC G06Q 40/04

(57) ABSTRACT

An alerting method by using trend lines of security information is implemented in a client device of a security information processing system. The method allows a client device to choose and drag at least one trend line in a technical diagram of security information to form at least one alerting line so as to generate at least one alerting condition corresponding to the trend line and the dragging operations. When the client device receives a plurality of security information, the client device checks if any of the received security information matches any one of the alerting conditions by passing the alerting line twice. If “YES”, then the client device generates an alerting signal and displays that matched security information on the client device, such that the user can see the matched security information and take it as a reference for deciding whether or not to buy or sell the security.

This application is a continue-in-part (CIP) of U.S. Ser. No. 14/822,336 filed on 2015 Aug. 10 which is pending, and also claims the benefit of Taiwan Patent Application Serial No. 104137914, filed on 2015 Nov. 17, the subject matter of which is incorporated herein by reference.

### BACKGROUND OF INVENTION

1. Field of the Invention

The invention relates to an alerting method by using trend lines of security information, and more particularly to the alerting method by using trend lines of security information that advising conditions of at least one alerting line corresponding to at least one trend line can be configured by the user and can issue an alerting signal upon when any of the security information matches any one of the alerting conditions by passing the alerting lines twice.

2. Description of the Prior Art

As information technology progress, people express their special needs in real-time and convenient information accessibility and their desires in advanced communicative devices. Various new multi-functional portable wireless communication devices are presented to the marketplace in an unprecedented fashion and an astonished speed, and all of which are simply to meet versatile and quick-changing demands. These communication devices includes various cellular phones, smart phones, devices with real-time stock info function, personal digital assistants, tablet computers, notebook computers, and any electronic device with wireless communication function.

Except for the aforesaid wireless communication devices, various software and apps are provided to those devices so as further to satisfy users in manifolds of convenience, real-time communication, in-time financing, jobs, entertainments, information accessing and so on. For example, specific wireless communication devices have facilitated the electronic trading for exchanging stocks, futures and the like valuable securities. The electronic service provided by the aforesaid devices can include the order-placing and more significantly the information sourcing of security trading information for helping the user to judge a prospective security and to also determine the trade timing for his/her own valuable securities.

For a user who trades valuable securities frequently, the trend line of a specific security regarding historical or intraday trading is usually an important reference for predicting future trading of this specific security. By observing the historical trend lines for the concerned security, the user can better understand possible trend of this security and thus can organize a feasible trading scheme for this security. Hence, if an alerting method by using trend lines of security information can be provided to automatically check and screen the enormous security trading information, and can furnish an automatic alerting function to notify that specific securities have met some predetermined patterns of trend lines; then, the user may gain more help in predicting the timing for buy or sell and in determining the trading price for the security.

Nevertheless, among all the technical analytic data and the related services from the security-related companies, these data and services usually use a plenty amount of terminologies and professional words in the security field, people who want to utilize these technical analytic data and the related services from the security-related companies need to get familiar with these terminologies and professional words in advance, and further need to able to handle the mathematical algorithms for these technical analysis. Hence, for those people who don't have the related knowledge in the security field, it is hard to be beneficial from the help of the analytical indexes (not limited to the trend line) in determining both the pricing and the timing for trading the securities. Definitely, the nowadays visual-plot display method further helps users in a more straightforward way in determining the investment timing of the interested security.

In addition, current trend-line alerting methods usually advice clients to buy or sell the specific security immediately as soon as the instant price of the security passes the trend line. Apparently, such a move does overlook the possibility that the price of the security might keep going down or up after passing the trend line, and thus a risk of losing big money is always there to the clients. Hence, further improvement upon the trend-line alerting method is definitely necessary.

### SUMMARY OF THE INVENTION

Accordingly, it is the primary object of the present invention to provide an alerting method by using trend lines of security information, implemented in a client device of a security information processing system, can allow the user of the client device to click and drag at least one trend line in the technical graph so as to generate at least one corresponding alerting-line advising condition. After the client device receives a plurality of security information, check if any of the security information meets any one of the advising conditions by passing the alerting line twice. If “YES”, then issue an alerting signal, and post the matched security information on the client device to alert the user and so as to provide the user a reference for deciding whether or not to buy or sell the security.

It is another object of the present invention to provide an alerting method by using trend lines of security information, which can allow the user to configure an alerting line parallel to the trend line by clicking and dragging the trend line so as to form the advising conditions of the alerting line for checking the late-coming security information.

In one embodiment of the present invention, the user can configure the advising conditions of the alerting line by a graphic and visual operation. Thus, the user can directly judge if the configured advising condition of the alerting line satisfies the buy-or-sell timing of the specific security. Importantly, by providing the present invention, ordinary people without professional knowledge of the securities can also use easily the method of the present invention to access the technical analytic data and index of the securities while in judging the timing of buy or sell for the concerned securities.

In the present invention, the alerting method by using trend lines of security information, implemented in a client device of a security information processing system, comprises the following steps.

Step (A): The user operates the client device to setup the graphic parameters for at least one trend line in the client device. The trend-line graphic parameters include at least a security target and a time duration.

Step (B): According to the security target and the time duration contained in the trend line graphic parameters, compute and then display a technical graph and at least one trend line of the security target on a touch screen of the client device.

Step (C): According to the setup operation upon the at least one trend line on the touch screen by the user, at least one alerting line for the at least one trend line can be generated. The individual alerting line is parallel to the corresponding trend line, and each individual alerting line is to check an advising condition of the corresponding alerting line in the following security information of the security target.

Step (D): The client device receives at least one the security information of the security target from an external source, and check if any of the received security information of the security target matches any one of the advising conditions by passing the alerting line twice. If the check result is “YES”, then an alerting signal is issued and the corresponding security information is displayed on the client device. If the check result is “NO”, then no alerting signal is generated.

In one embodiment of the present invention, each of the security information contains trading information of the security target within a specific time period after the aforesaid time duration. Also, the advising condition of the alerting line would judge the slope of the alerting line to adjust the check condition for a timing after the aforesaid time duration.

In one embodiment of the present invention, the method for computing the trend line of Step (B) includes the following steps.

Step (B1): A plurality of historical trading records regarding the security target within the time duration is searched and then retrieved from the memory of the client device, and a technical graph is formed according to the historical trading records.

Step (B2): Locate a plurality of band highs and a plurality of band lows on the technical graph.

Step (B3): According to the band highs and the band lows, label the respective trend line corresponding to the band highs and the band lows.

In one embodiment of the present invention, the technical graph includes a plurality of Candlesticks (also referred as K bars) formed in accordance with the plurality of the historical trading records. In Step (B2), the method for locating the plurality of band highs and the plurality of band lows includes the following criteria.

Criterion 1: Define the closing price of the first Candlestick within the time duration as a reference point of rule 1, and compare the closing price of the following Candlestick to the reference point of rule 1 of this Candlestick. If the closing price of the following Candlestick is higher than the reference point of rule 1 of this Candlestick, then the reference point of rule 1 is updated by the closing price of the following Candlestick. Such a comparison is kept executing upon the next following Candlestick. If the closing prices of the following m Candlesticks are all lower than the reference point of rule 1, then label the reference point of rule 1 as a band high of rule 1. Thereafter, similar comparison keeps going to compare the closing price of the next following Candlestick to the reference point of rule 1, till the last Candlestick within the time duration is processed. According to Criterion 1, all the band highs (LH1˜LHn) of rule 1 within the time duration can be located, in which the LH1 stands for the first band high of rule 1 meeting Criterion 1 within the time duration, and the LHn stands for the n-th band high of rule 1 meeting Criterion 1 within the time duration. In this embodiment, the m and the n are both integers larger than zeros, and preferably the m is a positive integer smaller than 8; for example, 3≦m≦8.

Criterion 2: Define the closing price of the first Candlestick within the time duration as a reference point of rule 2, and compare the closing price of the following Candlestick to the reference point of rule 2 of this Candlestick. Such a comparison is kept executing upon the next following Candlestick. If the closing price of the following Candlestick is lower than the reference point of rule 2 of this Candlestick, then the reference point of rule 2 is updated by the closing price of the following Candlestick. If the closing prices of the following m Candlesticks are all higher than the reference point of rule 2, then label the reference point of rule 2 as a band low of rule 1. Thereafter, similar comparison keeps going to compare the closing price of the next following Candlestick to the reference point of rule 2, till the last Candlestick within the time duration is processed. According to Criterion 2, all the band lows (LL1˜LLn) of rule 2 within the time duration can be located, in which the LL1 stands for the first band low of rule 2 meeting Criterion 2 within the time duration, and the LLn stands for the n-th band low of rule 2 meeting Criterion 2 within the time duration.

Criterion 3: Define the closing price of the last Candlestick within the time duration as a reference point of rule 3, and compare the closing price of the preceding Candlestick to the reference point of rule 3 of this Candlestick. Such a comparison is kept executing upon the further preceding Candlestick. If the closing price of the preceding Candlestick is higher than the reference point of rule 3 of this Candlestick, then the reference point of rule 3 is updated by the closing price of the preceding Candlestick. If the closing prices of the preceding m Candlesticks are all lower than the reference point of rule 3, then label the reference point of rule 3 as a band high of rule 3. Thereafter, similar comparison keeps going to compare the closing price of the further preceding Candlestick to the reference point of rule 3, till the first Candlestick within the time duration is processed. According to Criterion 3, all the band highs (RH1˜RHn) of rule 3 within the time duration can be located, in which the RH1 stands for the first band high of rule 3 meeting Criterion 3 within the time duration, and the RHn stands for the n-th band high of rule 3 meeting Criterion 3 within the time duration.

Criterion 4: Define the closing price of the last Candlestick within the time duration as a reference point of rule 4, and compare the closing price of the preceding Candlestick to the reference point of rule 4 of this Candlestick. Such a comparison is kept executing upon the further preceding Candlestick. If the closing price of the preceding Candlestick is lower than the reference point of rule 4 of this Candlestick, then the reference point of rule 4 is updated by the closing price of the preceding Candlestick. If the closing prices of the preceding m Candlesticks are all higher than the reference point of rule 4, then label the reference point of rule 4 as a band low of rule 4.

Thereafter, similar comparison keeps going to compare the closing price of the further preceding Candlestick to the reference point of rule 4, till the first Candlestick within the time duration is processed. According to Criterion 4, all the band lows (RL1˜RLn) of rule 4 within the time duration can be located, in which the RL1 stands for the first band low of rule 4 meeting Criterion 4 within the time duration, and the RLn stands for the n-th band low of rule 4 meeting Criterion 4 within the time duration. Basically, the application of the aforesaid embodiment is to use the closing price as the reference point. However, in some other embodiments in accordance with the present invention, the highest price or the lowest price of the Candlestick can be also applied as the reference point.

In the aforesaid criteria, the number n is an integer greater than zero. The number m is an integral less than 8.

In one embodiment of the present invention, the method for determining and then labeling the at least one trend line in Step (B3) further includes the following steps. In the following description, define the symbol N(•) as the number of “•”.

Step (B31): A trend-line pattern of the trend line is judged by comparing the numbers of the band highs and the band lows as follows.

If N(LH)≧N(RH) and N(RL)≧N(LL), then the pattern of the trend line is defined as an upward trend track.

If N(LL)≧N(RL) and N(RH)≧N(LH), then the pattern of the trend line is defined as a downward trend track.

If N(LH)>N(RH) and N(LL)>N(RL), then the pattern of the trend line is defined as a divergent track.

If N(RH)>N(LH) and N(RL)>N(LL), then the pattern of the trend line is defined as a convergent track.

Step (B32): Base on the result of Step (B31) to determine and label the at least one trend line as follows.

If the pattern of the trend line is an upward trend track, then locate the maximum value of the LHs, and connect the maximum LH with each LH. Define and label an upward resistance line of the upward trend track to the connection line that is the closest to have a zero slope (from a positive slope side). Then, locate the minimum value of the RLs, and connect the minimum RL with each RL. Define and label an upward support line of the upward trend track to the connection line that is the closest to have a zero slope (from a positive slope side).

If the pattern of the trend line is a downward trend track, then locate the minimum value of the LLs, and connect the minimum LL with each LL. Define and label a downward support line of the downward trend track to the connection line that is the closest to have a zero slope (from a negative slope side). Then, locate the maximum value of the RHs, and connect the maximum RH with each RH. Define and label a downward resistance line of the downward trend track to the connection line that is the closest to have a zero slope (from a negative slope side).

If the pattern of the trend line is a divergent trend track, then locate the maximum value of the LHs, and connect the maximum LH with each LH. Define and label an upward resistance line of the divergent trend track to the connection line that is the closest to have a zero slope (from a positive slope side). Then, locate the minimum value of the LLs, and connect the minimum LL with each LL. Define and label a downward support line of the divergent trend track to the connection line that is the closest to have a zero slope (from a negative slope side).

If the pattern of the trend line is a convergent trend track, then locate the maximum value of the RHs, and connect the maximum RH with each RH. Define and label a downward resistance line of the convergent trend track to the connection line that is the closest to have a zero slope (from a negative slope side). Then, locate the minimum value of the RLs, and connect the minimum RL with each RL. Define and label an upward support line of the convergent trend track to the connection line that is the closest to have a zero slope (from a positive slope side).

In one embodiment of the present invention, the method for generating the at least one alerting line in Step (C) includes the following steps.

Step (C1): Start to form the at least one alerting line.

Step (C2): Check if any of the trend lines displayed on the touch screen is chosen and dragged. If “YES”, then generate a translated line according to the click-and-drag operation upon the trend line. If “NO”, go back to Step (C1).

Step (C3): Check if the click-and-drag operation is released. If “YES”, then define the translated line after releasing the click-and-drag operation as an alerting line corresponding to the chosen and dragged trend line. If “NO”, go back to Step (C3). In the present invention, the alerting line is parallel to the chosen and dragged trend line.

In one embodiment of the present invention, the alerting line can include at least one of an upper trend-line alerting line and a lower trend-line alerting line. Based on the slope of the upper trend-line alerting line, a present-day price and a preceding-day price with respect to the upper trend-line alerting line can be calculated. Also, based on the slope of the lower trend-line alerting line, a present-day price and a preceding-day price with respect to the lower trend-line alerting line can be calculated. Further, the security information includes at least a trading price of the present day and the closing price of the preceding day for the security target. In the aforesaid step (D), at least one of the following two checking conditions shall be involved.

Checking condition 1: When the trading price in the security information of the security target is smaller than the present-day price of the upper trend-line alerting line, and the preceding-day closing price is larger than the preceding-day price of the upper trend-line alerting line, then the alerting signal is issued to propose a sale of the security target.

Checking condition 2: When the trading price in the security information of the security target is larger than the present-day price of the lower trend-line alerting line, and the preceding-day closing price is smaller than the preceding-day price of the lower trend-line alerting line, then the alerting signal is issued to propose a buy of the security target.

All these objects are achieved by the alerting method using trend lines of security information described below.

### BRIEF DESCRIPTION OF THE DRAWINGS

The present invention will now be specified with reference to its preferred embodiment illustrated in the drawings, in which:

FIG. 1 shows schematically an embodiment of a security information processing system for performing an alerting method by using trend lines of security information in accordance with the preset invention;

FIG. 2 is a flowchart of an embodiment of the alerting method by using trend lines of security information in accordance with the present invention;

FIG. 3 is a flowchart of an embodiment of a process for computing a trend line in the alerting method by using trend lines of security information in accordance with the present invention;

FIG. 4A is a schematic chart of an embodiment of the trend lines in an upward trend track computed by the process of FIG. 3;

FIG. 4B is a schematic chart of an embodiment of the trend lines in a downward trend track computed by the process of FIG. 3;

FIG. 4C is a schematic chart of an embodiment of the trend lines in a convergent trend track computed by the process of FIG. 3;

FIG. 5 is a flowchart of an embodiment of a process for adjusting the alerting line in the alerting method by using trend lines of security information in accordance with the present invention;

FIG. 6 is a schematic diagram of an embodiment according to the process of FIG. 5;

FIG. 7A shows schematically an embodiment of checking if the upper trend-line alerting line is passed twice in accordance with the step 26 of FIG. 2; and

FIG. 7B shows schematically an embodiment of checking if the lower trend-line alerting line is passed twice in accordance with the step 26 of FIG. 2.

### DESCRIPTION OF THE PREFERRED EMBODIMENT

The invention disclosed herein is directed to an alerting method by using trend lines of security information. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the present invention, the alerting method by using trend lines of security information is implemented in a client device of a security information processing system, and can allow the user of the client device to click and drag at least one trend line (or called as a trend-line alerting line) in the technical graph so as to generate at least one corresponding alerting-line advising condition. After the client device receives a plurality of security information, check if any of the received security information of the security target matches any one of the advising conditions by passing the alerting line twice. If “YES”, then issue an alerting signal, and post the matched security information on the client device to alert the user and so as to provide the user a reference for deciding whether or not to buy or sell the security.

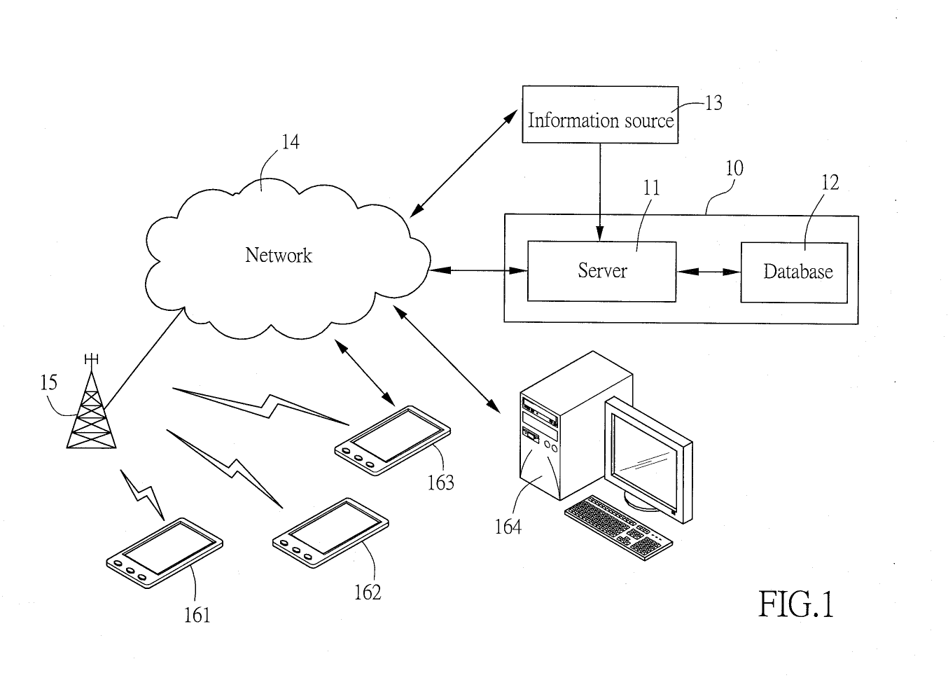

Referring now to FIG. 1, an embodiment of a security information processing system for fulfilling the alerting method by using trend lines of security information in accordance with the present invention is shown in a block diagram.

This embodiment of the security information processing system includes a server 11, at least one database 12, an information source 13, a communicative medium 14, a communicative servicing system 15, and a plurality of client devices 161, 162, 163, 164. The server 11 and the database 12 are integrally to form a security information servicing system 10. The server 11 can receive a plurality of security trading information from the at least one information source 13, perform an analysis upon the received security trading information, and then store the analytic results into the at least one database 12 (a harddisk for example). The server 11 can receive connection requests from and then establish the connection with a plurality of client devices 161, 162, 163, 164 via a communicative medium 14. As the communicative connections are established, the client devices 161, 162, 163, 164 can log in the server 11 to further access the service provided by the server 11, which the service includes, but not limited to, download the trading information or static data of the security stored in the at least one database 12 from the server and so on. In the present invention, the trading information or statistic data of the security are commonly called as the security information.

The data connection among the client devices 161, 162, 163, 164, the server 11 and the information source 13 can be established by utilizing the communicative medium 14 provided by the at least one communicative servicing system 15. In this embodiment, the security information processing system 10 is to provide information service regarding the valuable securities, in which the valuable securities includes, but not limited to, stocks, futures, warrants, funds, bonds and so on. The information source 13 or sources is/are the source/sources accessible to the server 11 and the client devices 161, 162, 163, 164, and can include, but not limited to, real-time or/and historical databases provided by security exchanges, security dealers, banks, news, television and broadcast media, private enterprises and so on. The communicative servicing system 15 can be, but not limited to, GSM850/900/1800/1900, a CDMA, a WCDMA, a PHS, a GPRS, a WiMAX, an LTE and any system the like. The client devices 161, 162, 163, 164 can be, but not limited to, stock machines having a touch screen, PDAs, smart phones, the like handheld electronic devices, a tablet, notebook or desktop computer having a touch screen. The communicative medium 14 can include at least one of a mobile-phone communicative medium, a wireless network communicative medium, and a network medium.

In the present invention, the alerting method by using trend lines of security information can be implemented in any of the client devices 161, 162, 163, 164 of the security information processing system. The client devices 161, 162, 163, 164 can include individually respective touch screens and memories for the user to operate through touching the specific touch screen, so as to allow the specific client device to perform the alerting method by using trend lines of security information.

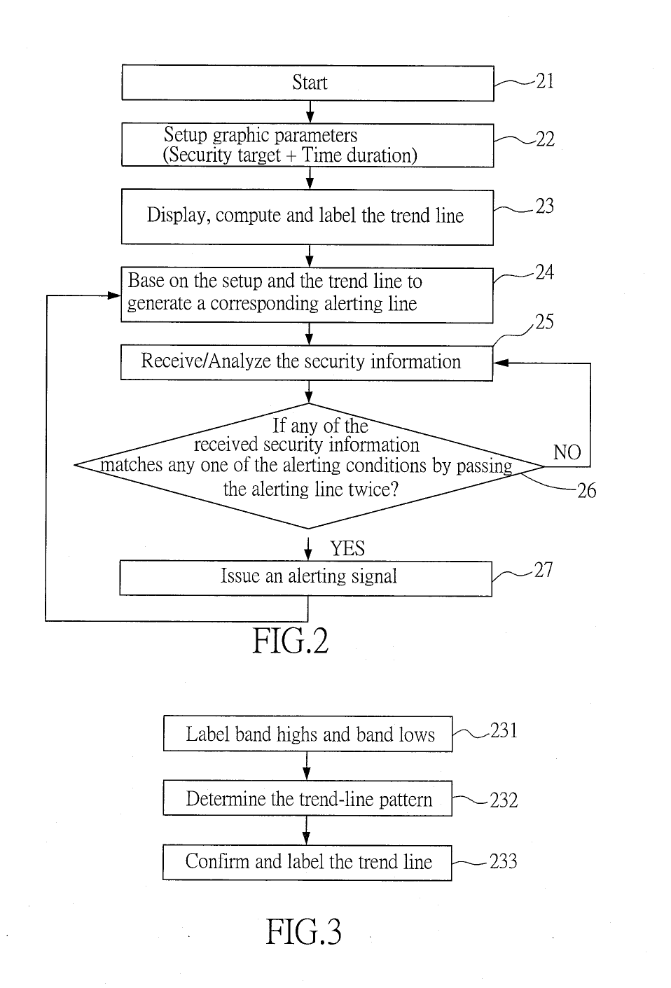

In FIG. 2, a flowchart for an embodiment of the alerting method by using trend lines of security information in accordance with the present invention is shown. This embodiment of the method includes the following steps.

Step 21: Start. The user utilizes the client device to perform the alerting method by using trend lines of security information in accordance with the present invention.

Step 22: Setup graphic parameters for the trend line. The user operates the client device to setup the graphic parameters for at least one trend line in the client device. The trend-line graphic parameters include at least a security target and a time duration. In the present invention, the trend-line graphic parameters can be configured by the user or automatically set by the system itself. For example, the time duration can be preset as a 60-day (or 60-candlestick) duration. The security target can be a stock, a futures, a warrant, a fund, a bond, or any valuable security the like in any individual stock, any sector, or any grail stock. The time duration can be a time period assigned by the user, for example (but not limited to) a 20-day period, a 60-day period, a half year, a year and so on. Alternatively, the time duration can be a time parameter defined on the technical graph by the user, for example (but not limited to) the duration for an intraday chart, a daily chart, a weekly chart, a monthly chart, a quarterly chart, or a yearly chart.

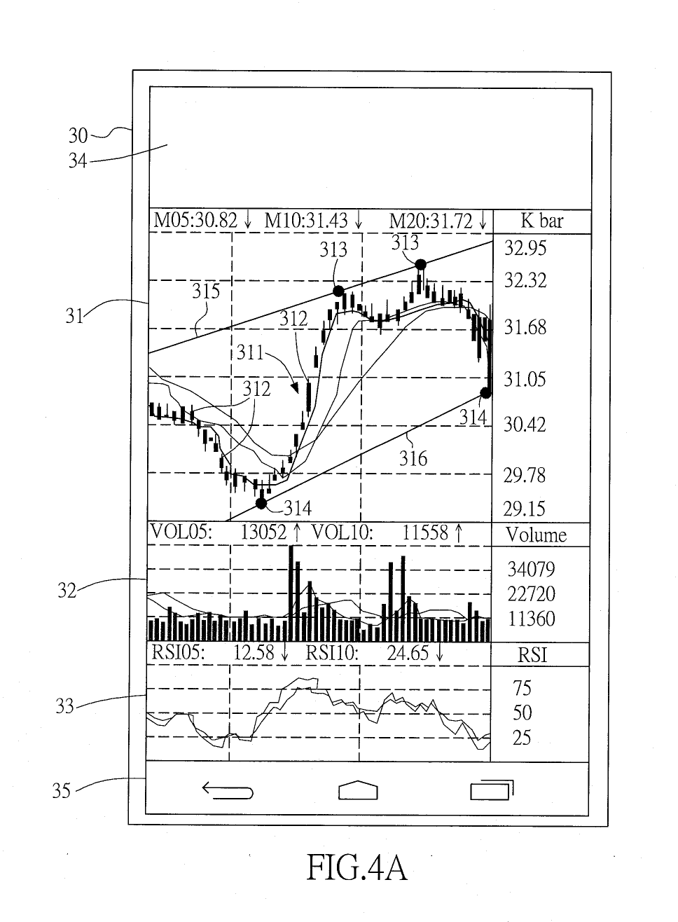

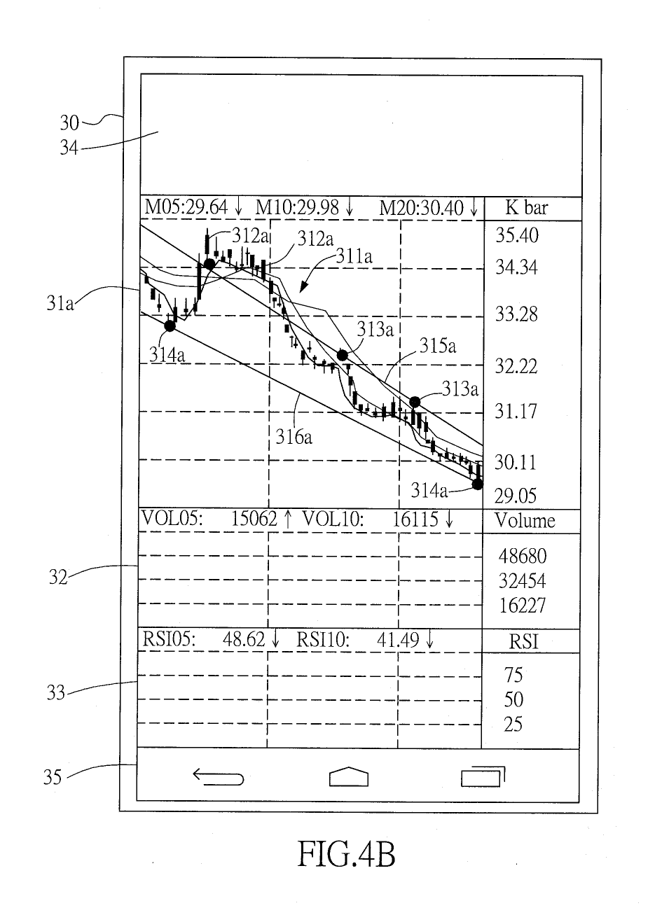

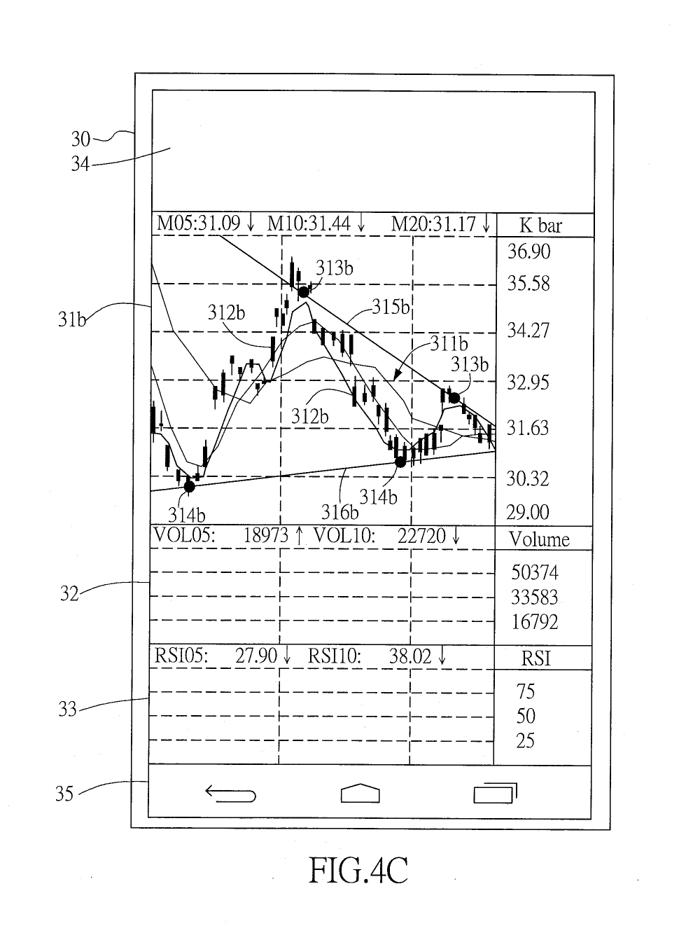

Step 23: Display the corresponding technical graph and label the computed trend lines in the technical graph. After the user has configured the security target and the time duration of the trend-line graphic parameters, the client device would search and retrieve a plurality of historical security information for the security target and the time duration from the memory. The plurality of the historical security information can include any historical trading record regarding the security target within the time duration, such as opening prices, intraday highs, intraday lows, closing prices, trading volumes, and any trading record the like. As long as the client device captures the aforesaid historical security information (historical trading records based on the security target and the time duration within the trend-line graphic parameters), then the corresponding technical graph and at least one trend line for the security target can be displayed on the touch screen of the client device. Details for computing the trend lines according to the alerting method by using trend lines of security information in accordance with the present invention would be elucidated as follows by referring to FIG. 3, FIG. 4A thru FIG. 4C.

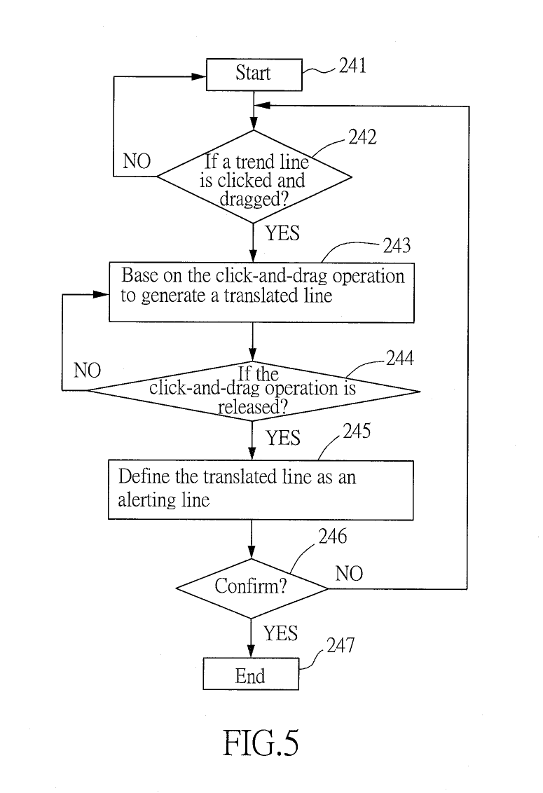

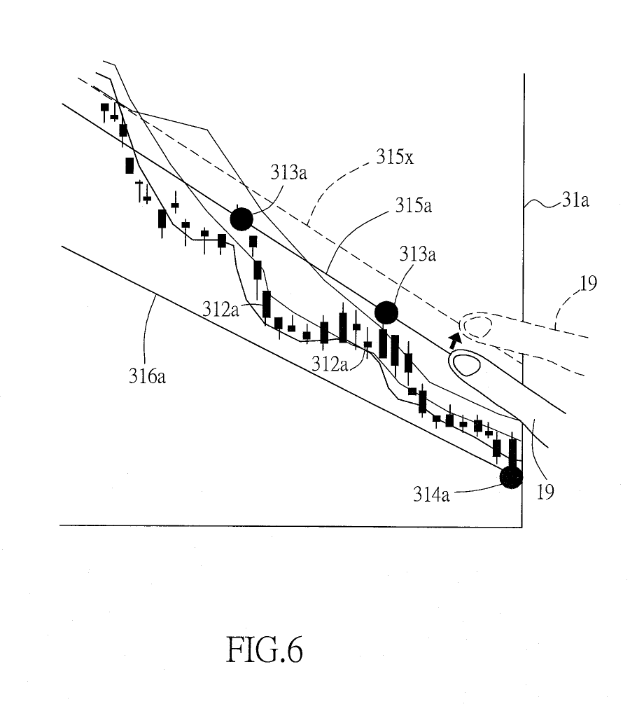

Step 24: Adjust an alerting line of the trend line according to the user's click-and-drag operation upon the corresponding trend line. According to the setup operation upon the at least one trend line on the touch screen by the user, at least one alerting line for the at least one trend line can be generated. The individual alerting line is parallel to the corresponding trend line, and each individual alerting line is to check an advising condition of the corresponding alerting line in the following security information of the security target. In the present invention, there are two methods to generate the alerting line from the trend line. One is to use the alerting line preset in the system, and another is that the user configure the alerting line by himself/herself. In the case that the user decides to apply the preset alerting line after he/she observes the technical graph and the trend line of the security target within the time duration on the touch screen of the client device, he/she needs only to choose the “system preset value” displayed simultaneously on the touch screens. Then, the client device would formulate automatically some alerting lines for corresponding trend lines according to system preset parameters. Each of the alerting lines would be parallel to the corresponding trend line and spaced from the corresponding trend line (i.e. along the direction of the trading price) by a preset percentage increment. For example (but not limited hereto), the percentage increment can be ±M % of the trading price, in which the M can be 3, 5, 10 or other integer. On the other hand, in the case that the user decides to configure the preset alerting line by himself/herself after he/she observes the technical graph and the trend line of the security target within the time duration on the touch screen of the client device, he/she can choose or click directly the trend line and then drag a duplicated trend line, as an alerting line now, to a desired position on the touch screen. In accordance with the alerting method by using trend lines of security information of the present invention, details by embodiments for how the user can configure the alerting line corresponding to the trend line would be elucidated lately by accompanying FIG. 5 and FIG. 6.

Step 25: Receive and analyze the security information. As long as the user setups the alerting lines (i.e. the advising conditions of the alerting line are determined), the client device would receive and further analyze at least one new security information of the security target. Each of the new security information can include trading information of the security target within a new time period after the aforesaid time duration. It is noted that the trading information of the security information is not included in the technical graph, but in the time period (updated) after that for the technical graph. In the preferred embodiment of the present invention, the security information can be the real-time trading information of the security target, in which the real-time trading information includes at least one real-time trading price and a corresponding real-time trading volume.

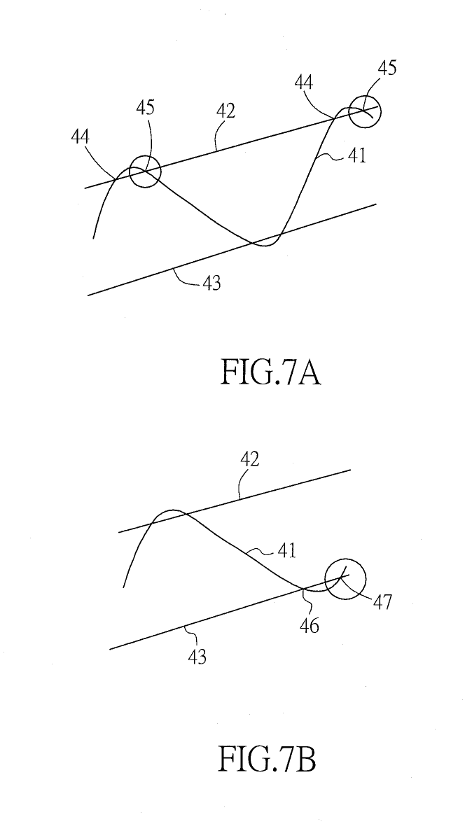

Step 26: Check the security information if any advising condition of the alerting line is met. Check if the real-time trading price contained in the security information of a specific security target satisfies the advising condition of the received security information of the security target matching any one of the advising conditions by passing the alerting line twice. If the check result is “YES”, then an alerting signal (Step 27) is issued and the corresponding security information would be displayed on the client device so as to alert the user to determine if a decision of buy or sell the security target can be made. On the other hand, if the check result is “NO”, then no alerting signal is generated and go back to perform Step 25 again. In the present invention, for the advising condition of the alerting line would judge the slope of the alerting line to further adjust automatically the condition to be checked after the time duration, so, according to the alerting method by using trend lines of security information of the present invention, the advising condition of the alerting line is not a fixed value to buy or sell, but a time-variant price depending on the concurrent slope of the alerting line. Such an arrangement of the alerting method in accordance with the present invention is also new in the art. Details for checking if any of the received security information of the security target matches any one of the advising conditions by passing the alerting line twice would be further elucidated in the following descriptions corresponding to FIG. 7A and FIG. 7B.

Referring now to FIG. 3, a flowchart of an embodiment of the method for computing the trend line (in Step 23) for the alerting method by using trend lines of security information of the present invention is shown. As shown, the method for computing the trend line includes the following steps.

Firstly, a plurality of historical trading records regarding the security target within the time duration is searched and then retrieved from the memory of the client device. Based on the historical trading records, a technical graph is formed, in which the technical graph includes a plurality of candlesticks (Candlesticks) regarding the security target within the time duration.

Then, perform Step 231 to label band highs and band lows. In this step, a plurality of band highs and a plurality of band lows are located and then labeled on the technical graph.

In one embodiment of the present invention, the method for sorting the band highs and the band lows in the Step 231 can include the following criteria.

Criterion 1: Define the closing price of the first Candlestick within the time duration as a reference point of rule 1, and compare the closing price of the following Candlestick to the reference point of rule 1 of this Candlestick. If the closing price of the following Candlestick is higher than the reference point of rule 1 of this Candlestick, then the reference point of rule 1 is updated by the closing price of the following Candlestick. Such a comparison is kept executing upon the next following Candlestick. If the closing prices of the following m Candlesticks are all lower than the reference point of rule 1, then label the reference point of rule 1 as a band high of rule 1. Thereafter, similar comparison keeps going to compare the closing price of the next following Candlestick to the reference point of rule 1, till the last Candlestick within the time duration is processed. According to Criterion 1, all the band highs (LH1˜LHn) of rule 1 within the time duration can be located, in which the LH1 stands for the first band high of rule 1 meeting Criterion 1 within the time duration, and the LHn stands for the n-th band high of rule 1 meeting Criterion 1 within the time duration. In this embodiment, the m and the n are both integers larger than zeros, and preferably the m is a positive integer smaller than 8; for example, 3≦m≦8.

Criterion 2: Define the closing price of the first Candlestick within the time duration as a reference point of rule 2, and compare the closing price of the following Candlestick to the reference point of rule 2 of this Candlestick. Such a comparison is kept executing upon the next following Candlestick. If the closing price of the following Candlestick is lower than the reference point of rule 2 of this Candlestick, then the reference point of rule 2 is updated by the closing price of the following Candlestick. If the closing prices of the following m Candlesticks are all higher than the reference point of rule 2, then label the reference point of rule 2 as a band low of rule 1. Thereafter, similar comparison keeps going to compare the closing price of the next following Candlestick to the reference point of rule 2, till the last Candlestick within the time duration is processed. According to Criterion 2, all the band lows (LL1˜LLn) of rule 2 within the time duration can be located, in which the LL1 stands for the first band low of rule 2 meeting Criterion 2 within the time duration, and the LLn stands for the n-th band low of rule 2 meeting Criterion 2 within the time duration.

Criterion 3: Define the closing price of the last Candlestick within the time duration as a reference point of rule 3, and compare the closing price of the preceding Candlestick to the reference point of rule 3 of this Candlestick. Such a comparison is kept executing upon the further preceding Candlestick. If the closing price of the preceding Candlestick is higher than the reference point of rule 3 of this Candlestick, then the reference point of rule 3 is updated by the closing price of the preceding Candlestick. If the closing prices of the preceding m Candlesticks (wherein the number m is equal to five in this embodiment) are all lower than the reference point of rule 3, then label the reference point of rule 3 as a band high of rule 3. Thereafter, similar comparison keeps going to compare the closing price of the further preceding Candlestick to the reference point of rule 3, till the first Candlestick within the time duration is processed. According to Criterion 3, all the band highs (RH1˜RHn) of rule 3 within the time duration can be located, in which the RH1 stands for the first band high of rule 3 meeting Criterion 3 within the time duration, and the RHn stands for the n-th band high of rule 3 meeting Criterion 3 within the time duration.

Criterion 4: Define the closing price of the last Candlestick within the time duration as a reference point of rule 4, and compare the closing price of the preceding Candlestick to the reference point of rule 4 of this Candlestick. Such a comparison is kept executing upon the further preceding Candlestick. If the closing price of the preceding Candlestick is lower than the reference point of rule 4 of this Candlestick, then the reference point of rule 4 is updated by the closing price of the preceding Candlestick. If the closing prices of the preceding m Candlesticks are all higher than the reference point of rule 4, then label the reference point of rule 4 as a band low of rule 4. Thereafter, similar comparison keeps going to compare the closing price of the further preceding Candlestick to the reference point of rule 4, till the first Candlestick within the time duration is processed. According to Criterion 4, all the band lows (RL1˜RLn) of rule 4 within the time duration can be located, in which the RL1 stands for the first band low of rule 4 meeting Criterion 4 within the time duration, and the RLn stands for the n-th band low of rule 4 meeting Criterion 4 within the time duration.

In the present invention, the m and the n are both integers larger than zeros, and particularly the m is a positive integer smaller than 8. In this embodiment, the m is preferably to be ranged as 3≦m≦8, m=5 for example.

Basically, the application of the aforesaid embodiment is to use the closing price as the reference point. However, in some other embodiments in accordance with the present invention, the highest price or the lowest price of the Candlestick can be also applied as the reference point.

Then, perform Step 232 to judge the pattern of the trend line. According to the band highs and the band lows, the pattern of the trend line in the technical graph can be determined.

In one embodiment of the present invention, the aforesaid trend-line pattern of Step 232 is judged by comparing the numbers of the band highs and the band lows as follows. In the following description, define the symbol N(•) as the number of “˜”.

If N(LH)≧N(RH) and N(RL)≧N(LL), then the pattern of the trend line is defined as an upward trend track.

If N(LL)≧N(RL) and N(RH)≧N(LH), then the pattern of the trend line is defined as a downward trend track.

If N(LH)>N(RH) and N(LL)>N(RL), then the pattern of the trend line is defined as a divergent track.

If N(RH)>N(LH) and N(RL)>N(LL), then the pattern of the trend line is defined as a convergent track.

In the present invention, if N(LH)=N(RH) or N(LL)=N(RL), it implies that the security target is in a consolidation or regrouping state, and thus no upward or downward trend track can be located. Under this circumstance, the system and the method of this present invention would display a message “The security target is regrouped within the time period.” on the screen at the client end.

Then, perform Step 233 to determine and label the trend line onto the technical graph. According to the band highs and the band lows, label the trend line corresponding to the band highs and the band lows.

In one embodiment of the present invention, the method to determine the trend line in Step 233 is to base on the trend-line pattern judged in Step 232 to perform the labeling of the trend line on the technical graph. The determination method of the trend line is explained as follows.

If the pattern of the trend line is an upward trend track, then locate the maximum value of the LHs, and connect the maximum LH with each LH. Define and label an upward resistance line of the upward trend track to the connection line that is the closest to have a zero slope (from a positive slope side). Then, locate the minimum value of the RLs, and connect the minimum RL with each RL. Define and label an upward support line of the upward trend track to the connection line that is the closest to have a zero slope (from a positive slope side).

If the pattern of the trend line is a downward trend track, then locate the minimum value of the LLs, and connect the minimum LL with each LL. Define and label a downward support line of the downward trend track to the connection line that is the closest to have a zero slope (from a negative slope side). Then, locate the maximum value of the RHs, and connect the maximum RH with each RH. Define and label a downward resistance line of the downward trend track to the connection line that is the closest to have a zero slope (from a negative slope side).

If the pattern of the trend line is a divergent trend track, then locate the maximum value of the LHs, and connect the maximum LH with each LH. Define and label an upward resistance line of the divergent trend track to the connection line that is the closest to have a zero slope (from a positive slope side). Then, locate the minimum value of the LLs, and connect the minimum LL with each LL. Define and label a downward support line of the divergent trend track to the connection line that is the closest to have a zero slope (from a negative slope side).

If the pattern of the trend line is a convergent trend track, then locate the maximum value of the RHs, and connect the maximum RH with each RH. Define and label a downward resistance line of the convergent trend track to the connection line that is the closest to have a zero slope (from a negative slope side). Then, locate the minimum value of the RLs, and connect the minimum RL with each RL. Define and label an upward support line of the convergent trend track to the connection line that is the closest to have a zero slope (from a positive slope side).

Referring now to FIG. 4A thru FIG. 4C, embodiments of trend lines graphed in accordance with the steps of FIG. 3 for the alerting method by using trend lines of security information according to the present invention are respectively shown, in which the trend-line pattern of FIG. 4A is an upward trend track, that of FIG. 4B is a downward trend track, and that of FIG. 4C is a convergent track.

As shown in FIG. 4A, after the labeling process of FIG. 3 upon the trend line is complete, the touch screen 30 of the client device would display the following information regarding the security target within the time duration; a technical graph 31, a volume chart 32, a relative strength index (RSI) chart 33, a function selection area 34 and a function key area 35. In the technical graph 31, a plurality of Candlesticks 312 (also referred as K bar in FIGS. 4A, 4B and 4C), plural band highs 313, plural band lows 314, an upward resistance line 315, a downward support line 316 and plural average lines 311 such as the 5-day average line, the 10-day average line, the 20-day average line, and so on are demonstrated. The volume chart 32 displays the trading volume, the RSI chart 33 displays the RSI lines, the function selection area 34 displays a plurality of information regarding the security target such as (but not limited to) a name of the security target, a code thereof and so on, and some other function selections for performing the alerting method by using trend lines of security information in accordance with the present invention, and the function key area 35 includes function keys to operate the client device such as (but not limited to) a page-back button, a file-manager button, and other operational buttons. Similarly, the touch screen 30 of the client device in either FIG. 4B or FIG. 4C also display technical graphs 31a, 31b, a volume chart 32, a relative strength index (RSI) chart 33, a function selection area 34 and a function key area 35, regarding the security target within the time duration. Also in the technical graph 31a or 31b, a plurality of Candlesticks 312a, 312b, plural band highs 313a, 313b, plural band lows 314a, 314b, a downward resistance line 315a, 315b, a downward (or upward) support line 316a, 316b, and plural average lines 311a, 311b are included for the security target within the time duration.

As long as Step 233 is complete, the user can setup and adjust the alerting line either preset by the system or configured by the user so as further to form the advising conditions of the alerting line.

Referring now to FIG. 5, an operational process for adjusting the alerting line in the alerting method by using trend lines of security information in accordance with the present invention is shown. In the present invention, the alerting method by using trend lines of security information can further allow the user to configure an alerting line parallel to the trend line by a manner of choosing and dragging the trend line, so as thereby to form the advising conditions of the alerting line for checking the late-coming security information.

The step 24 of FIG. 2 can be performed in detail by the following steps as shown in FIG. 5.

Step 241: Start to form the at least one alerting line.

Step 242: Check if any of the trend lines displayed on the touch screen is chosen and dragged. If “YES”, then perform Step 243 to generate a translated line according to the click-and-drag operation upon the trend line. If “NO”, go back to Step 241.

Step 244: Check if the click-and-drag operation is released. If “YES”, then perform Step 245 to define the translated line after releasing the click-and-drag operation as an alerting line corresponding to the chosen and dragged trend line. If “NO”, go back to Step 243. In the present invention, the alerting line is parallel to the chosen and dragged trend line.

Step 245: As long as the trend line is chosen and dragged so as to form the corresponding alerting line, a further question would be provided to the user to ask if the alerting line is acceptable. If “YES”, then perform Step 247 to end this operation. If “NO”, go back to Step 242 for repeating the click-and-drag operation upon the specific trend line.

Referring now to FIG. 6, a schematic diagram of an embodiment according to the process of FIG. 5 is shown. In this embodiment, the user can manipulate his/her fingers to click and drag any trend line 315a so as further to move vertically upward to form the alerting line 315x. In another embodiment of the present invention, the user can hand-input upward or downward offset percentages with respect to the trend line so as to produce the corresponding alerting line; for example, to input M for M % offset.

By providing the security information processing system and the method for the same, the user can configure the advising conditions of the alerting line by a graphic and visual operation. Thus, the user can directly judge if the configured advising condition of the alerting line satisfies the buy-or-sell timing of the specific security. Importantly, by providing the present invention, ordinary people without professional knowledge of the securities can also use easily the method of the present invention to access the technical analytic data and index of the securities while in judging the timing of buy or sell for the concerned securities.

Refer now to FIG. 7A and FIG. 7B, in which FIG. 7A shows schematically an embodiment of checking if the upper trend-line alerting line is passed twice in accordance with the step 26 of FIG. 2, and FIG. 7B shows schematically an embodiment of checking if the lower trend-line alerting line is passed twice in accordance with the step 26 of FIG. 2.

As shown in FIG. 7A and FIG. 7B, the alerting line of the present invention includes an upper trend-line alerting line 42 and a lower trend-line alerting line 43. The upper and lower trend-line alerting lines 42, 43 represent the upper portion and the lower portion of the technical graph 41 penetrating plural Candlesticks of the security target, respectively. The position numbered 44 in FIG. 7A is the position that the trading price of the security target passes the upper trend-line alerting line 42 at the first time. Further, the position numbered 45 in FIG. 7A is the position that the trading price of the security target passes the upper trend-line alerting line 42 at the second time. The meaning of the trading price of the security target to pass the upper trend-line alerting line 42 at the first time indicates that firstly the closing prices of a number (5 for example) of the preceding Candlesticks of the security target are all located under the upper trend-line alerting line 42, then the closing price of a specific Candlestick penetrates up through the upper trend-line alerting line 42, and thus the time point of this specific Candlestick is defined as the position point that the trading price of the security target passes the upper trend-line alerting line 42 at the first time. On the other hand, the meaning of the trading price of the security target to pass the upper trend-line alerting line 42 at the second time indicates that, after the upper trend-line alerting line 42 is passed at the first time, the instant trading price of the security target is smaller than the present-day price of the upper trend-line alerting line 42 (namely, the upper trend-line alerting line 42 is penetrated in a downward movement).

Similarly, the position numbered 46 in FIG. 7B is the position that the trading price of the security target passes the lower trend-line alerting line 43 at the first time. Further, the position numbered 47 in FIG. 7B is the position that the trading price of the security target passes the lower trend-line alerting line 43 at the second time. The meaning of the trading price of the security target to pass the lower trend-line alerting line 43 at the first time indicates that firstly the closing prices of a number (5 for example) of the preceding Candlesticks of the security target are all located above the lower trend-line alerting line 43, then the closing price of a specific Candlestick penetrates down through the lower trend-line alerting line 43, and thus the time point of this specific Candlestick is defined as the position point that the trading price of the security target passes the lower trend-line alerting line 43 at the first time. On the other hand, the meaning of the trading price of the security target to pass the lower trend-line alerting line 43 at the second time indicates that, after the lower trend-line alerting line 43 is passed at the first time, the instant trading price of the security target is larger than the present-day price of the lower trend-line alerting line 43 (namely, the lower trend-line alerting line 43 is penetrated in an upward movement).

Currently, the conventional method using the trend-line alerting line usually proposes the client to buy or sell the security target as soon as the instant trading price of the security target hits the trend-line alerting line at the very first time (i.e., at the position numbered 44 or 46 in FIG. 7A or FIG. 7B, respectively). Thereupon, the possibility that the technical graph of the security target may fall or rise continuously without a follow-up hit at the trend-line alerting line is completely overlook. Hence, the risk accompanying the aforesaid possibility is thus unable to be wiped off. However, by providing the alerting method of the present invention, the proposal of selling or buying the security target is made at the position numbered 45 or 47 of FIG. 7A or FIG. 7B, respectively, after the the upper or lower trend-line alerting line 42 or 43 is passed twice by the instant trading price of the security target. Namely, the sell-or-buy proposal in accordance with the present invention is made after a reverse-trend condition is confirmed for the security target. Therefore, the investment risk for the client can be significantly reduced.

In one embodiment of the present invention, a present-day price and a preceding-day price of the upper trend-line alerting line can be calculated according to the slope of the upper trend-line alerting line, and also a present-day price and a preceding-day price of the lower trend-line alerting line can be calculated according to the slope of the lower trend-line alerting line. The security information of the present invention includes a present-day instant trading price of the security target, a present-day highest trading price of the security target, a present-day lowest trading price of the security target, and a preceding-day closing price of the security target. In the aforesaid step (D) of the alerting method, at least one of the following two checking conditions shall be involved.

Checking condition D1: When the trading price in the security information of the security target is smaller than the present-day price of the upper trend-line alerting line, and the preceding-day closing price is larger than the preceding-day price of the upper trend-line alerting line or the present-day highest trading price is larger than the present-day price of the upper trend-line alerting line, then the alerting signal is issued to propose a sale of the security target.

Checking condition D2: When the trading price in the security information of the security target is larger than the present-day price of the lower trend-line alerting line, and the preceding-day closing price is smaller than the preceding-day price of the lower trend-line alerting line or the present-day lowest trading price is smaller than the present-day price of the lower trend-line alerting line, then the alerting signal is issued to propose a buy of the security target.

By providing the foregoing checking conditions D1 and D2, the security information of any security target can be checked whether the advising conditions of passing the alerting line twice is fulfilled or not. Thus, not only an instant alerting message can be obtained, but the situation of turning back in pricing during the exchanging hours can also be alerted.

In a further embodiment of the present invention, in the aforesaid step (D) of the alerting method, at least one of the following two checking conditions shall be involved.

Checking condition D3: When the trading price in the security information of the security target is smaller than the present-day price of the upper trend-line alerting line, and the preceding-day closing price is larger than the preceding-day price of the upper trend-line alerting line, then the alerting signal is issued to propose a sale of the security target.

Checking condition D4: When the trading price in the security information of the security target is larger than the present-day price of the lower trend-line alerting line, and the preceding-day closing price is smaller than the preceding-day price of the lower trend-line alerting line, then the alerting signal is issued to propose a buy of the security target.

By providing the foregoing checking conditions D3 and D4, the security information of any security target can be checked whether the advising conditions of passing the alerting line twice is fulfilled or not. Thus, only the situation that the price of the security target is confirmed solidly to break through the alerting line, and then the alerting signal can be issued. Hence, fake signals for breaking through during the exchanging hours can be substantially located, and thus the investment risk can be reduced to a minimum. In this present invention, this embodiment with checking conditions D3 and D4 for examining if the alerting line is passed twice is preferable.

While the present invention has been particularly shown and described with reference to a preferred embodiment, it will be understood by those skilled in the art that various changes in form and detail may be without departing from the spirit and scope of the present invention.

What is claimed is:

1. An alerting method by using trend lines of security information, implemented in a client device of a security information processing system, comprising the steps of:
Step (A): using the client device to setup at least one trend line graphic parameter in the client device, the at least one trend line graphic parameter including at least a security target and a time duration;
Step (B): based on the security target and the time duration contained in the at least one trend line graphic parameter to compute and then display a technical graph and at least one trend line of the security target on a touch screen of the client device;
Step (C): based on a setup operation of a user upon the at least one trend line on the touch screen to generate at least one alerting line for the at least one trend line, the at least one alerting line being individually parallel to the corresponding at least one trend line, each of the at least one alerting line being to check an advising condition of the corresponding at least one alerting line in a following security information of the security target; and
Step (D): the client device receiving at least one of the following security information of the security target from an external source, checking if any of the received security information of the security target matches any one of the advising conditions by passing the alerting line twice, issuing an alerting signal and displaying the matched following security information on the client device if a check result is “YES”, and generating no alerting signal if the check result is “NO”.

2. The alerting method by using trend lines of security information of claim 1, wherein the advising condition of the at least one alerting line judges a slope of the at least one alerting line to adjust a check condition for a timing after the time duration.

3. The alerting method by using trend lines of security information of claim 1, wherein, in Step (B), a method for computing the at least one trend line includes the steps of:
Step (B1): searching and retrieving a plurality of historical trading records regarding the security target within the time duration and then retrieved from the memory of the client device, and forming a technical graph according to the historical trading records;
Step (B2): locating a plurality of band highs and a plurality of band lows on the technical graph; and
Step (B3): based on the plurality of band highs and the plurality of band lows to determine and label the respective at least one trend line corresponding to the plurality of band highs and the plurality of band lows.

4. The alerting method by using trend lines of security information of claim 3, wherein the technical graph includes a plurality of Candlesticks (candlesticks) formed in accordance with the historical trading records, wherein, in Step (B2), a method for locating the band highs and the band lows includes the following criteria:
Criterion 1: defining a closing price of the first Candlestick within the time duration as a reference point of rule 1, comparing another closing price of the following Candlestick to the reference point of rule 1 of this first Candlestick, updating the reference point of rule 1 by said another closing price of the following Candlestick if said another closing price of the following Candlestick is higher than the reference point of rule 1 of this first Candlestick, keeping executing the comparing and the updating upon the next following Candlestick, and labeling the reference point of rule 1 as a band high of rule 1 if said another closing prices of the following m Candlesticks are all lower than the reference point of rule 1, wherein the comparing, the updating and the labeling are kept going to the next following Candlestick till the last Candlestick within the time duration is processed, wherein, according to Criterion 1, all the band highs (LH1˜LHn) of rule 1 within the time duration can be located, in which the LH1 stands for the first band high of rule 1 meeting Criterion 1 within the time duration, and the LHn stands for the n-th band high of rule 1 meeting Criterion 1 within the time duration;
Criterion 2: defining a closing price of the first Candlestick within the time duration as a reference point of rule 2, comparing another closing price of the following Candlestick to the reference point of rule 2 of this first Candlestick, updating the reference point of rule 2 by said another closing price of the following Candlestick if said another closing price of the following Candlestick is lower than the reference point of rule 1 of this first Candlestick, keeping executing the comparing and the updating upon the next following Candlestick, and labeling the reference point of rule 2 as a band low of rule 2 if said another closing prices of the following m Candlesticks are all higher than the reference point of rule 2, wherein the comparing, the updating and the labeling are kept going to the next following Candlestick till the last Candlestick within the time duration is processed, wherein, according to Criterion 2, all the band lows (LL1˜LLn) of rule 2 within the time duration can be located, in which the LL1 stands for the first band low of rule 2 meeting Criterion 2 within the time duration, and the LLn stands for the n-th band low of rule 2 meeting Criterion 2 within the time duration;
Criterion 3: defining a closing price of the last Candlestick within the time duration as a reference point of rule 3, comparing another closing price of the preceding Candlestick to the reference point of rule 3 of this last Candlestick, updating the reference point of rule 3 by said another closing price of the preceding Candlestick if said another closing price of the preceding Candlestick is higher than the reference point of rule 3 of this last Candlestick, keeping executing the comparing and the updating upon the further preceding Candlestick, and labeling the reference point of rule 3 as a band high of rule 3 if said another closing prices of the preceding m Candlesticks are all lower than the reference point of rule 3, wherein the comparing, the updating and the labeling are kept going to the further preceding Candlestick till the first Candlestick within the time duration is processed, wherein, according to Criterion 3, all the band highs (RH1˜RHn) of rule 3 within the time duration can be located, in which the RH1 stands for the first band high of rule 3 meeting Criterion 3 within the time duration, and the RHn stands for the n-th band high of rule 3 meeting Criterion 3 within the time duration; and
Criterion 4: defining a closing price of the last Candlestick within the time duration as a reference point of rule 4, comparing another closing price of the preceding Candlestick to the reference point of rule 4 of this last Candlestick, updating the reference point of rule 4 by said another closing price of the preceding Candlestick if said another closing price of the preceding Candlestick is lower than the reference point of rule 4 of this last Candlestick, keeping executing the comparing and the updating upon the further preceding Candlestick, and labeling the reference point of rule 4 as a band low of rule 4 if said another closing prices of the preceding m Candlesticks are all higher than the reference point of rule 4, wherein the comparing, the updating and the labeling are kept going to the further preceding Candlestick till the first Candlestick within the time duration is processed, wherein, according to Criterion 4, all the band lows (RL1˜RLn) of rule 4 within the time duration can be located, in which the RL1 stands for the first band low of rule 4 meeting Criterion 4 within the time duration, and the RLn stands for the n-th band low of rule 4 meeting Criterion 4 within the time duration;
wherein the numbers n and m are both integers greater than zero, and the number m is less than 8.

5. The alerting method by using trend lines of security information of claim 4, wherein, in Step (B3), a method for determining and then labeling the at least one trend line includes the steps of:
Step (B31): judging a trend-line pattern of the at least one trend line by comparing numbers of the band highs and the band lows, wherein, defining the symbol N(•) as the number of “•”,
the trend-line pattern of the at least one trend line is defined as an upward trend track if N(LH)≧N(RH) and N(RL)≧N(LL),
the trend-line pattern of the at least one trend line is defined as a downward trend track if N(LL)≧N(RL) and N(RH)≧N(LH),
the trend-line pattern of the at least one trend line is defined as a divergent trend track if N(LH)>N(RH) and N(LL)>N(RL), and
the trend-line pattern of the at least one trend line is defined as a convergent trend track if N(RH)>N(LH) and N(RL)>N(LL);
Step (B32): based on the result of Step (B31) to determine and label the at least one trend line,
wherein, if the trend-line pattern of the at least one trend line is the upward trend track, then locate the maximum value of the LHs and connect the maximum LH with each LH, defining and labeling an upward resistance line of the upward trend track to a connection line that is the closest to have a zero slope (from a positive slope side), and then also locate the minimum value of the RLs and connect the minimum RL with each RL, defining and labeling an upward support line of the upward trend track to a connection line that is the closest to have a zero slope (from a positive slope side);
wherein, if the trend-line pattern of the at least one trend line is the downward trend track, then locate the minimum value of the LLs and connect the minimum LL with each LL, defining and labeling a downward support line of the downward trend track to a connection line that is the closest to have a zero slope (from a negative slope side), and then also locate the maximum value of the RHs and connect the maximum RH with each RH, defining and labeling a downward resistance line of the downward trend track to a connection line that is the closest to have a zero slope (from a negative slope side);
wherein, if the trend-line pattern of the at least one trend line is a divergent trend track, then locate the maximum value of the LHs and connect the maximum LH with each LH, defining and labeling an upward resistance line of the divergent trend track to a connection line that is the closest to have a zero slope (from a positive slope side), and then also locate the minimum value of the LLs and connect the minimum LL with each LL, defining and labeling a downward support line of the divergent trend track to a connection line that is the closest to have a zero slope (from a negative slope side);
wherein, if the trend-line pattern of the at least one trend line is a convergent trend track, then locate the maximum value of the RHs and connect the maximum RH with each RH, defining and labeling a downward resistance line of the convergent trend track to a connection line that is the closest to have a zero slope (from a negative slope side), and then also locate the minimum value of the RLs and connect the minimum RL with each RL, defining and labeling an upward support line of the convergent trend track to a connection line that is the closest to have a zero slope (from a positive slope side).

6. The alerting method by using trend lines of security information of claim 1, wherein the alerting line includes an upper trend-line alerting line and a lower trend-line alerting line, a present-day price and a preceding-day price of the upper trend-line alerting line being calculated according to a slope of the upper trend-line alerting line, another present-day price and another preceding-day price of the lower trend-line alerting line being calculated according to another slope of the lower trend-line alerting line; wherein the security information includes a present-day instant trading price of the security target and a preceding-day closing price of the security target; wherein the Step (D) further includes at least one of:
Checking condition 1: when the trading price in the security information of the security target is smaller than the present-day price of the upper trend-line alerting line and the preceding-day closing price is larger than the preceding-day price of the upper trend-line alerting line, then the alerting signal being issued to propose a sale of the security target; and
Checking condition 2: when the trading price in the security information of the security target is larger than the present-day price of the lower trend-line alerting line, and the preceding-day closing price is smaller than the preceding-day price of the lower trend-line alerting line, then the alerting signal being issued to propose a buy of the security target.

7. An alerting method by using trend lines of security information, implemented in a client device of a security information processing system, comprising the steps of:
Step (A): using the client device to setup at least one trend line graphic parameter in the client device, the at least one trend line graphic parameter including at least a security target and a time duration;
Step (B): based on the security target and the time duration contained in the at least one trend line graphic parameter to compute and then display a technical graph and at least one trend line of the security target on a touch screen of the client device;
Step (C): generating at least one alerting line corresponding to the respective at least one trend line, wherein each of the at least one alerting line is to check an advising condition of the corresponding alerting line in the following security information of the security target;
Step (D): the client device receiving at least one of the following security information of the security target from an external source, checking if any of the received security information of the security target matches any one of the advising conditions by passing the alerting line twice, issuing an alerting signal and displaying the matched following security information on the client device if a check result is “YES”, and generating no alerting signal if the check result is “NO”.

8. The alerting method by using trend lines of security information of claim 7, wherein the advising condition of the at least one alerting line judges a slope of the at least one alerting line to adjust a check condition for a timing after the time duration.

9. The alerting method by using trend lines of security information of claim 7, wherein, in Step (B), a method for computing the at least one trend line includes the steps of:
Step (B1): searching and retrieving a plurality of historical trading records regarding the security target within the time duration and then retrieved from the memory of the client device, and forming a technical graph according to the historical trading records;
Step (B2): locating a plurality of band highs and a plurality of band lows on the technical graph; and
Step (B3): based on the plurality of band highs and the plurality of band lows to determine and label the respective at least one trend line corresponding to the plurality of band highs and the plurality of band lows.

10. The alerting method by using trend lines of security information of claim 9, wherein the technical graph includes a plurality of Candlesticks (candlesticks) formed in accordance with the historical trading records, wherein, in Step (B2), a method for locating the band highs and the band lows includes the following criteria:
Criterion 1: defining a closing price of the first Candlestick within the time duration as a reference point of rule 1, comparing another closing price of the following Candlestick to the reference point of rule 1 of this first Candlestick, updating the reference point of rule 1 by said another closing price of the following Candlestick if said another closing price of the following Candlestick is higher than the reference point of rule 1 of this first Candlestick, keeping executing the comparing and the updating upon the next following Candlestick, and labeling the reference point of rule 1 as a band high of rule 1 if said another closing prices of the following m Candlesticks are all lower than the reference point of rule 1, wherein the comparing, the updating and the labeling are kept going to the next following Candlestick till the last Candlestick within the time duration is processed, wherein, according to Criterion 1, all the band highs (LH1˜LHn) of rule 1 within the time duration can be located, in which the LH1 stands for the first band high of rule 1 meeting Criterion 1 within the time duration, and the LHn stands for the n-th band high of rule 1 meeting Criterion 1 within the time duration;
Criterion 2: defining a closing price of the first Candlestick within the time duration as a reference point of rule 2, comparing another closing price of the following Candlestick to the reference point of rule 2 of this first Candlestick, updating the reference point of rule 2 by said another closing price of the following Candlestick if said another closing price of the following Candlestick is lower than the reference point of rule 1 of this first Candlestick, keeping executing the comparing and the updating upon the next following Candlestick, and labeling the reference point of rule 2 as a band low of rule 2 if said another closing prices of the following m Candlesticks are all higher than the reference point of rule 2, wherein the comparing, the updating and the labeling are kept going to the next following Candlestick till the last Candlestick within the time duration is processed, wherein, according to Criterion 2, all the band lows (LL1˜LLn) of rule 2 within the time duration can be located, in which the LL1 stands for the first band low of rule 2 meeting Criterion 2 within the time duration, and the LLn stands for the n-th band low of rule 2 meeting Criterion 2 within the time duration;
Criterion 3: defining a closing price of the last Candlestick within the time duration as a reference point of rule 3, comparing another closing price of the preceding Candlestick to the reference point of rule 3 of this last Candlestick, updating the reference point of rule 3 by said another closing price of the preceding Candlestick if said another closing price of the preceding Candlestick is higher than the reference point of rule 3 of this last Candlestick, keeping executing the comparing and the updating upon the further preceding Candlestick, and labeling the reference point of rule 3 as a band high of rule 3 if said another closing prices of the preceding m Candlesticks are all lower than the reference point of rule 3, wherein the comparing, the updating and the labeling are kept going to the further preceding Candlestick till the first Candlestick within the time duration is processed, wherein, according to Criterion 3, all the band highs (RH1˜RHn) of rule 3 within the time duration can be located, in which the RH1 stands for the first band high of rule 3 meeting Criterion 3 within the time duration, and the RHn stands for the n-th band high of rule 3 meeting Criterion 3 within the time duration; and
Criterion 4: defining a closing price of the last Candlestick within the time duration as a reference point of rule 4, comparing another closing price of the preceding Candlestick to the reference point of rule 4 of this last Candlestick, updating the reference point of rule 4 by said another closing price of the preceding Candlestick if said another closing price of the preceding Candlestick is lower than the reference point of rule 4 of this last Candlestick, keeping executing the comparing and the updating upon the further preceding Candlestick, and labeling the reference point of rule 4 as a band low of rule 4 if said another closing prices of the preceding m Candlesticks are all higher than the reference point of rule 4, wherein the comparing, the updating and the labeling are kept going to the further preceding Candlestick till the first Candlestick within the time duration is processed, wherein, according to Criterion 4, all the band lows (RL1˜RLn) of rule 4 within the time duration can be located, in which the RL1 stands for the first band low of rule 4 meeting Criterion 4 within the time duration, and the RLn stands for the n-th band low of rule 4 meeting Criterion 4 within the time duration;
wherein the numbers n and m are both integers greater than zero, and the number m is less than 8.

11. The alerting method by using trend lines of security information of claim 10, wherein, in Step (B3), a method for determining and then labeling the at least one trend line includes the steps of:
Step (B31): judging a trend-line pattern of the at least one trend line by comparing numbers of the band highs and the band lows, wherein, defining the symbol N(•) as the number of “•”,
the trend-line pattern of the at least one trend line is defined as an upward trend track if N(LH)≧N(RH) and N(RL)≧N(LL),
the trend-line pattern of the at least one trend line is defined as a downward trend track if N(LL)≧N(RL) and N(RH)≧N(LH),
the trend-line pattern of the at least one trend line is defined as a divergent trend track if N(LH)>N(RH) and N(LL)>N(RL), and
the trend-line pattern of the at least one trend line is defined as a convergent trend track if N(RH)>N(LH) and N(RL)>N(LL);
Step (B32): based on the result of Step (B31) to determine and label the at least one trend line,
wherein, if the trend-line pattern of the at least one trend line is the upward trend track, then locate the maximum value of the LHs and connect the maximum LH with each LH, defining and labeling an upward resistance line of the upward trend track to a connection line that is the closest to have a zero slope (from a positive slope side), and then also locate the minimum value of the RLs and connect the minimum RL with each RL, defining and labeling an upward support line of the upward trend track to a connection line that is the closest to have a zero slope (from a positive slope side);
wherein, if the trend-line pattern of the at least one trend line is the downward trend track, then locate the minimum value of the LLs and connect the minimum LL with each LL, defining and labeling a downward support line of the downward trend track to a connection line that is the closest to have a zero slope (from a negative slope side), and then also locate the maximum value of the RHs and connect the maximum RH with each RH, defining and labeling a downward resistance line of the downward trend track to a connection line that is the closest to have a zero slope (from a negative slope side);
wherein, if the trend-line pattern of the at least one trend line is a divergent trend track, then locate the maximum value of the LHs and connect the maximum LH with each LH, defining and labeling an upward resistance line of the divergent trend track to a connection line that is the closest to have a zero slope (from a positive slope side), and then also locate the minimum value of the LLs and connect the minimum LL with each LL, defining and labeling a downward support line of the divergent trend track to a connection line that is the closest to have a zero slope (from a negative slope side);
wherein, if the trend-line pattern of the at least one trend line is a convergent trend track, then locate the maximum value of the RHs and connect the maximum RH with each RH, defining and labeling a downward resistance line of the convergent trend track to a connection line that is the closest to have a zero slope (from a negative slope side), and then also locate the minimum value of the RLs and connect the minimum RL with each RL, defining and labeling an upward support line of the convergent trend track to a connection line that is the closest to have a zero slope (from a positive slope side).

12. The alerting method by using trend lines of security information of claim 7, wherein the alerting line includes an upper trend-line alerting line and a lower trend-line alerting line, a present-day price and a preceding-day price of the upper trend-line alerting line being calculated according to a slope of the upper trend-line alerting line, another present-day price and another preceding-day price of the lower trend-line alerting line being calculated according to another slope of the lower trend-line alerting line; wherein the security information includes a present-day instant trading price of the security target and a preceding-day closing price of the security target; wherein the Step (D) further includes at least one of:
Checking condition 1: when the trading price in the security information of the security target is smaller than the present-day price of the upper trend-line alerting line and the preceding-day closing price is larger than the preceding-day price of the upper trend-line alerting line, then the alerting signal being issued to propose a sale of the security target; and
Checking condition 2: when the trading price in the security information of the security target is larger than the present-day price of the lower trend-line alerting line, and the preceding-day closing price is smaller than the preceding-day price of the lower trend-line alerting line, then the alerting signal being issued to propose a buy of the security target.
